(19) United States
(12) Patent Application Publication
(10) Pub. No.: US 2015/0000156 A1
(43) Pub. Date: Jan. 1, 2015

(54) SPRAY DRYER EXHAUST TREATMENT AND ANAEROBIC DIGESTER

(71) Applicant: ANAERGIA INC., Burlington (CA)

(72) Inventors: Ashwani KUMAR, Mississauga (CA); Deonarine PHAGOO, Toronto (CA); Juan Carlos JOSSE, Mission Viejo, CA (US)

(21) Appl. No.: 14/314,171

(22) Filed: Jun. 25, 2014

Related U.S. Application Data
(60) Provisional application No. 61/840,078, filed on Jun. 27, 2013.

(51) Int. Cl. F26B 23/00; F26B 3/02

(52) U.S. Cl. CPC F26B 23/002; F26B 3/02
USPC 34/477; 34/86

(57) ABSTRACT

A spray dryer exhaust gas treatment system and process recovers waste heat, removes odors from the exhaust gas, or both. The spray dryer may be used to dry digestate from an anaerobic digester. Spray dryer exhaust is at least partially recirculated to the spray dryer, or condensable vapors are removed from the spray dryer exhaust, or both. Optionally, a bleed from a recirculating exhaust stream may pass through a combustion chamber. Preferably, waste heat is added to the recirculating exhaust stream or used to evaporate water upstream of the spray dryer. In a case where the spray dryer is used to treat digestate, a biogas burner may provide the combustion chamber and a source of waste heat. The system and method reduce odors from spray dryer exhaust by condensing odorous compounds, by combustion, or both while using waste heat and spray dryer exhaust gas recirculation to reduce energy consumption.

### RELATED APPLICATIONS

This application claims the benefit of U.S. Provisional Application No. 61/840,078 filed Jun. 27, 2013, which is incorporated herein by reference.

### FIELD

This specification relates to spray dryers and to anaerobic digestion.

### BACKGROUND

Spray drying is used in some industrial drying applications. The spray dryer produces particles or agglomerates that can often meet rigorous quality specifications relating to particle size distribution, bulk density or particle morphology. Spray dryers use direct contact between air, or another gas, and a solid-liquid mixture being dried. Thermal mass transfer heating takes place over a very short contact time. The mixture is atomized and the droplets are combined with a hot air stream. The hot air stream removes moisture from the atomized particles and then the hot air and dried particles are separated. For example, the hot air stream may pass through a cyclone in order to remove relatively large particles. Following the cyclone, the air may pass through a bag filter in order to remove fines. After the separation steps, the hot air exhausts from the dryer.

### INTRODUCTION

If a spray drier is used to dry digestate from an anaerobic digester, and possibly other mixtures, the exhausted air will be contaminated with volatile organics and have a foul odor. The volatile organics remain within the exhaust gas through the bag filter and other separation steps. In some cases, volatile organics can be removed after spray drying using a recuperative thermal oxidization process. However, when drying digestate the high volume of air and the corresponding low concentration of volatile organics would render the calorific value of the exhaust gas too low for effective treatment using this process. An alternative is to use a natural gas fired thermal oxidizer. However, this process would consume a large amount of natural gas with the heat energy required to treat the exhaust exceeding the heat energy required in the spray dryer itself. Although the quality of a spray dried product is typically very high, the energy consumption of a spray dryer using a gas fired thermal oxidizer to treat the exhaust gas would discourage the use of a spray dryer with digestate. The same concerns may also apply to other feed streams containing volatile organics or other odorous compounds.

This specification describes a spray dryer exhaust gas treatment system. The system recovers waste heat, removes one or more contaminants from the exhaust gas, or both. The spray dryer exhaust gas treatment system may be integrated with an anaerobic digester having a spray dryer used to dry digestate.

A spray dryer exhaust gas treatment system may have a condenser. The condenser extracts a condensate from the exhaust gas. The condensate contains water and one or more contaminants from the exhaust gas. Optionally, other contaminants in the exhaust gas may be combusted, for example in a burner fed with biogas from an anaerobic digester or in a burner used to heat a gas fed to the spray dryer.

A spray dryer or spray dryer exhaust gas treatment system may have means for using waste heat to reduce the energy required by the spray dryer. In some cases, at least a portion of spray dryer exhaust gas is recirculated to the spray dryer. In some cases, one or more heat exchangers may transfer heat from spray dryer exhaust gas being sent to a condenser to gas being sent to the spray dryer. In some cases, one or more heat exchangers may add waste heat extracted from the exhaust of a heater for gas entering the spray dryer to gas entering the spray dryer. In some cases, one or more heat exchangers may add waste heat extracted from the exhaust or cooling water of a biogas burner to gas being fed to the spray dryer. In some cases, an evaporator or heater powered at least in part by waste heat may heat, or remove water from, the feed stream to a spray dryer. One or more of these cases may be combined.

In a spray dryer exhaust treatment process, spray dryer exhaust is at least partially recirculated to the spray dryer, or condensable vapors are removed from the spray dryer exhaust, or preferably both. Optionally, a bleed from a recirculating exhaust stream may be passed through a combustion chamber. Preferably, waste heat is added to the recirculating exhaust stream or used to evaporate water upstream of the spray dryer. In a case where the spray dryer is used to treat digestate, a biogas burner may provide the combustion chamber and a source of waste heat. Alternatively, a heater for the spray dryer may provide the combustion chamber.

The systems and methods described above can be used to reduce odors from spray dryer exhaust by removing odorous compounds as condensate, by combustion, or both. Energy consumption is reduced by one or more of: recirculating at least some of the spray dryer exhaust, recovering heat from the exhaust gas travelling to a condenser, recovering waste heat from the exhaust of a heater for gas flowing to the spray dryer, and recovering waste heat from burning biogas. The spray dried product may be used as a fertilizer or soil enhancing product.

### FIGURES

FIG. 1 is a schematic process flow diagram of an anaerobic digester with a spray dryer exhaust treatment system.

### DETAILED DESCRIPTION

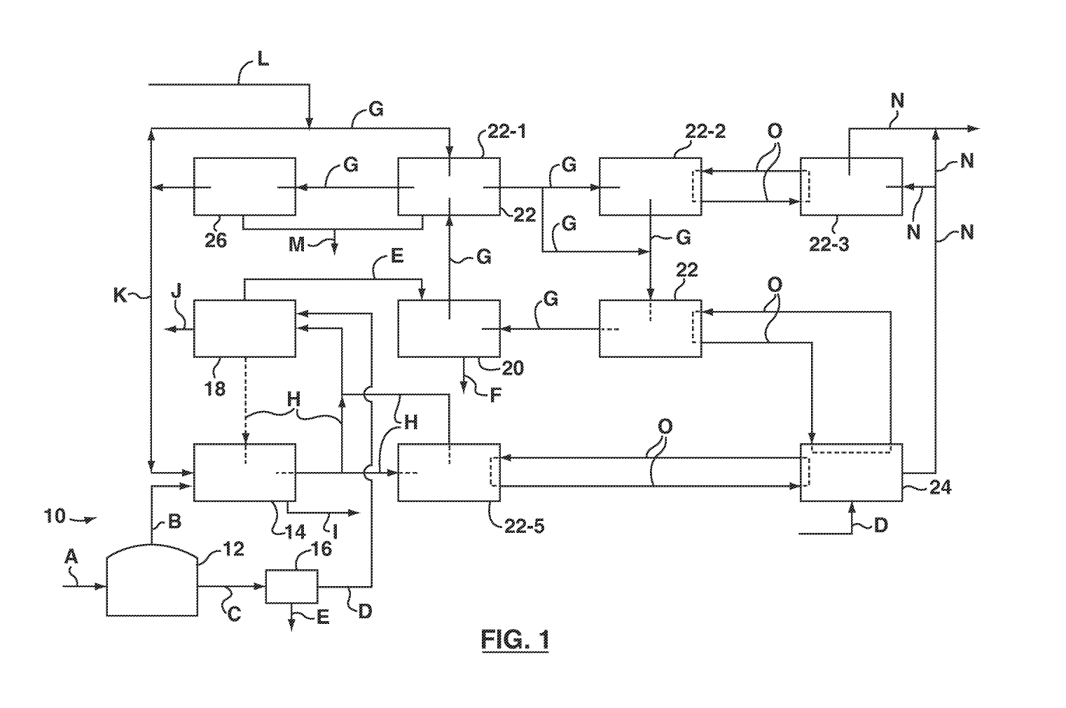

FIG. 1 shows an anaerobic digester 10. The anaerobic digester 10 has, among other things, a reactor 12, a biogas burner 14, an optional solid-liquid separation unit 16, an optional evaporator 18 and a spray dryer 20. The reactor 12 may have one or more covered tanks with mixers. Though not shown, the reactor 12 may also have a feed storage and conveying system, internal mixers, a heater, a service box, a digestate recirculation loop, or other known equipment used with anaerobic digesters. The biogas burner 14 may be a combined heat and power (CHP) unit. A CHP unit may be a reciprocating or turbine engine capable of burning methane and turning a generator to produce electricity, or a boiler producing steam that is used to turn a generator. The solid-liquid separation unit 16 may be, for example, a screw press or belt press. A screening surface in the solid-liquid separation unit may have an opening size of at least 500 microns. The evaporator 18 may be, for example, a self-cleaning two stage evaporator. The digester 10 may also have various associated conduits, pumps, controllers, sensors and other ancillary equipment.

The reactor 12 receives a feedstock A which may include, for example, one or more of waste activated sludge, industrial wastewater, solid waste or another form of waste biomass. The reactor 12 outputs biogas B to the biogas burner 14. The biogas B may be treated before being consumed by the biogas burner 14. The reactor 12 also outputs digestate C to the solid-liquid separation unit 16. The word digestate is sometimes used to refer to only the solids portion of sludge from an anaerobic digester, but in this description the word digestate also refers to a stream carrying solids from the digester.

Solid-liquid separation unit 16, if any, separates digestate C into liquid portion D, alternatively called filtrate, and solids portion E. Solids portion E may particles that are too large for nozzles or other equipment in the spray dryer 20, recalcitrant particles that are difficult to digest, or particles that are useful when separated and would add little value to a spray dried fertilizer product. For example, fibers may be removed from the liquid portion D and sold separately for animal bedding or compost. Alternatively or additionally, some solids portion E may be returned to the reactor 12 for recuperative thickening. Optionally, there may be multiple solid-liquid separation units 16, with an upstream unit used to remove fibers or other recalcitrant material and a downstream unit used for recuperative thickening. In a case where the feedstock A does not contain large recalcitrant solid particles, the solid-liquid separation unit 16 may be omitted.

Liquid portion D flows to the spray dryer 20, optionally through evaporator 18. Evaporator 18, if any, removes water from the liquid portion D to produce concentrated digestate E. Concentrated digestate E may have, for example, a total solids content of 10 to 20% by weight whereas liquid portion D is likely to have a total solids content in the range of 3 to 8% by weight. Optionally, an acid such as sulfuric acid may be added to the liquid portion D, preferably upstream of any evaporator 18. The acid helps reduce the loss of nitrogen as unionized ammonia gas in the evaporator 18 or spray dryer 20. Optionally, liquid portion D may pass through an ammonia stripper to separately recover nitrogen. Optionally, there may be a liquid portion D heater in place of or upstream of evaporator 18.

Evaporator 18 may be powered, at least in part, by heat from the biogas burner 14. In the example of FIG. 1, biogas burner 14 is a CHP incorporating a reciprocating engine. The engine is cooled by cooling water H flowing in a loop through a cooling jacket of the engine and evaporator 14. Cooling water H is heated by the engine and cooled by the evaporator 18. Distillate J produced by evaporator 18 is nearly pure water and may be re-used, for example as dilution water for a reactor 12 treating a very high solids content feedstock A, or discharged. The biogas burner 14 also produces burner exhaust gas I. Optionally, though not shown, the burner exhaust gas I can be used to further heat the cooling water H before it enters the evaporator 18 or to provide heat to another part of the digester 10. A heater for the liquid portion D may be powered, at least in part, as described in this paragraph for the evaporator 18.

Since water removed in the evaporator 18 does not need to be removed in the spray dryer 20, the evaporator reduces the energy consumption of the spray dryer 20. Further, the concentrate digestate E is heated in the evaporator 18 which further reduces the energy consumption of the spray dryer. Heating the liquid portion D, with or without an evaporator 18, using cooling water H or burner exhaust gas I or another available source of waste heat also reduces the energy consumption of the spray dryer 20 since hot water requires less energy to vaporise than cold water. Although all available sources of waste heat could be used to heat the gas fed to the spray dryer 20, the liquid portion D is relatively cool, for example about 30 degrees C., relative to other fluids in the digester 10. Accordingly, it is typically more efficient to transfer at least some heat to the liquid portion D upstream of the spray dryer 20. Cooling water H leaving the biogas burner 14 is also relatively cool, for example about 90 degrees C., compared to other waste heat sources available in the digester 10 and is therefore suitable for heating liquid portion D. However, cooling water H and burner exhaust gas I could alternatively be used to provide heat to gas being fed to the spray dryer 20.

The primary source of heat for the gas fed to the spray dryer 20 is a heater 24. Heater 24 may be, for example, a natural gas fired thermal oil heater. Optionally, a heat exchanger 22-5 may be used to add additional heat to the cooling water H flowing to evaporator 18 from heater 24. In the example of FIG. 1, a sidestream of cooling water H passes through heat exchanger 22-5 to allow a variable portion of the cooling water H to be further heated by heater 24. An operator or controller can vary the portion of the cooling water H that passes through the heat exchanger 22-5 to follow fluctuations in the heat demand of the evaporator 18.

In the spray dryer 20, the concentrated digestate E is atomized and dried to produce dried product F. Dried product F is a fine product or powder containing one or more nutrients such as nitrogen or phosphorous. Dried product F may be used, for example, as a fertilizer or soil admixture, alone or in mixtures with other compounds. Optionally, dried product F may be granulated to produce a particle sized, for example, to be compatible with dry fertilizer spreading equipment. In a case in which nitrogen or another compound has been separately removed from digestate C, the removed compound may be blended back into the dried product F, for example as an ammonium salt, if desired.

Spray dryer 20 also produces dryer exhaust gas G. Typically, entrained particles and fines are separated from dryer exhaust gas G in the spray dryer 20, for example using a cyclone and bag filter. However, the dryer exhaust gas G still contains one or more contaminants evolved from the digestate in addition to air. The contaminants may include a condensable gas or vapor, a non-condensable gas, or possibly some remaining fines. At least some of the contaminants may be odor causing volatile organics. The dryer exhaust gas G is also hot, for example about 100 degrees C. At least some of the dryer exhaust gas G is recirculated and fed back to the spray dryer 20. In this way, heat energy in the exhaust gas G is returned to the spray dryer 20. Further, contaminants in the exhaust gas G are concentrated, which helps in removing them. To prevent excessive build-up of contaminants that are difficult to remove, a bleed stream K is removed from the recirculating dryer exhaust gas G. Make up air L is added as required to preserve a steady volume of gas in the loop of recirculating dryer exhaust gas G.

The dryer exhaust gas G flows through an exhaust gas treatment system including a condenser 26 or one or more heat exchangers 22 or, preferably, both. The exhaust gas treatment system does one or more of: retaining heat from the recirculating dryer exhaust gas G, adding waste heat to the recirculating dryer exhaust gas G, and removing water and one or more contaminants from the dryer exhaust gas.

Dryer exhaust gas G leaves the spray dryer 20 at approximately 100° C. and passes through an air-to-air heat exchanger 22-1. In heat exchanger 22-1, outgoing dryer exhaust gas G is used as a heat source for recirculated dryer exhaust gas G which, having passed though condenser 26, is at approximately 15° C. The condenser 26 may include a chiller that is cooled, for example, by a flow of water, ambient or any other available relatively cold fluid available to the digester 10 and, preferably, in need of heat. The condenser 26, and possibly also the heat exchanger 22-1, remove condensate M from the dryer exhaust gas G. Condensate M is primarily water removed in spray dryer 20. However, condensable contaminant gasses in the dryer exhaust gas G can also be removed. Further, water soluble non-condensable contaminants may be removed from the dryer exhaust gas G by dissolution into water in the condensate M. Fine solids may also be removed from the dryer exhaust gas G by being sorbed into water droplets. Optionally, the removal of contaminants may be enhanced providing a large surface area within the condenser 18 which becomes covered with a film of condensate M exposed to passing dryer exhaust gas G. Further, some condensate M may be recirculated through the condenser 26 as a mist, droplets or a film. In this case, the condenser 26 may be cooled, at least in part, by cooling the recirculating condensate M.

Contaminants, including odor causing contaminants, are removed with the condensate M to thereby reduce or avoid the energy consumption that would be required to thermally oxidize these contaminants. Water removed with condensate M also allows the dryer exhaust gas G to be recirculated to the spray dryer 20. The condenser 26 and heat exchanger 22-1 thereby conserve at least some of the heat of the recirculated exhaust gas G because bleed stream K may have only 30% or less, or 20% or less, of the volumetric flow rate at standard temperature and pressure (STP) of dryer exhaust gas G leaving the spray dryer 20. Further, bleed stream K is released at near ambient temperature but at least some of its heat differential relative to dryer exhaust gas G leaving the spray dryer 20 is transferred back into the recirculating dryer exhaust gas G.

Bleed stream K preferably passes through a combustion chamber. In the example of FIG. 1, bleed stream K is used as secondary combustion air for the biogas burner 14. In the biogas burner 14, at least some contaminants remaining in the bleed stream K may be mineralized, oxidized or otherwise destroyed or degraded. Alternatively, the bleed stream K may be used as combustion air for the heater 24 to be burned with natural gas P.

Dryer exhaust gas G that is not removed in bleed stream K is recirculated into a heat recovery loop leading back to the spray dryer 20. Make-up air L is added to the recirculating dryer exhaust gas G to compensate for the volume of air removed in bleed stream K. The recirculated dryer exhaust gas G, initially at approximately 15° C., is heated by dryer exhaust gas G leaving the spray dryer 20 as it passes through heat exchanger 22-1.

Following heat exchanger 22-1, the recirculating dryer exhaust gas G passes through another heat exchanger 22-2 where it is heated using waste heat from the exhaust N of heater 24. While the exhaust N may be used to heat recirculated exhaust gas G through an air to air heat exchanger, in the example of FIG. 1 exhaust N first heats oil O through gas-to-oil heat exchanger 22-3. Recirculating dryer exhaust gas G may bypass heat exchanger 22-2 at some times. Oil O from heat exchanger 22-3 can then be used to in another part of digester 10, for example to heat cooling water H through heat exchanger 22-5. Optionally, cooling water H can also be heated directly by a gas-to-water heat exchanger between heater exhaust N and cooling water H.

Recirculating dryer exhaust gas G may leave heat exchanger 22-2 at about 100 degrees C. The recirculating dryer exhaust gas G then passes through an oil-to-air heat exchanger 22-4 where it is heated using oil from the heater 24. Heater 24 may be a natural gas thermal oil heater. The temperature of the recirculating dryer exhaust gas G entering the spray dryer 20 is typically about 250 degrees C.

Other examples of systems and methods may be within the scope of the invention which is defined by the following claims.

We claim:

1. A process comprising steps of:
a) drying a liquid in a spray dryer to produce a dried substance and an exhaust gas;
b) passing at least some of the spray dryer exhaust gas through a heat exchanger to produce a cooled spray dryer exhaust gas;
c) passing at least some of the cooled spray dryer exhaust gas through a condenser to produce a dried spray dryer exhaust gas;
d) passing at least some of the dried spray dryer exhaust gas through the heat exchanger of step b) to produce a warmed spray dryer exhaust gas; and,
e) returning at least some of the warmed spray dryer exhaust gas to the spray dryer.

2. The process of claim 1 wherein the liquid is digestate.

3. The process of claim 2 wherein the digestate is produced in an anaerobic digester, the anaerobic digester produces a biogas, and at least some of the biogas is burned.

4. The process of claim 3 wherein heat from burning the biogas is added to the liquid before step a) or to the spray dryer exhaust gas after step b).

5. The process of claim 1 wherein the spray dryer exhaust gas is heated by a gas fired heater before step e).

6. The process of claim 5 wherein the spray dryer exhaust gas is heater by exhaust from the gas fired burner before step e).

7. The process of claim 1 further comprising steps of removing a bleed stream from the spray dryer exhaust gas and passing the bleed stream though a biogas burner or a gas fired heater.

8. A spray dryer exhaust gas treatment system comprising a condenser.

9. The system of claim 8 comprising a recirculation loop adapted to return a portion of spray dryer exhaust gas from the outlet of the condenser to a spray dryer.

10. The system of claim 8 comprising a conduit adapted to convey a portion of the spray dryer exhaust gas from the outlet of the condenser to a combustion chamber.

11. The system of claim 10 wherein the combustion chamber is within a biogas burner or a spray dryer feed gas heater.

12. A spray dryer comprising a spray dryer exhaust gas recirculation loop.

13. The spray dryer of claim 12 wherein the spray dryer exhaust gas recirculation group comprises a condenser and a heat exchanger configured to transfer heat from spray dryer exhaust gas being sent to a condenser to gas being sent to the spray dryer.

14. The spray dryer of claim 12 comprising a heater for recirculated spray dryer exhaust gas and a heat exchanger adapted to transfer heat from heater exhaust to the recirculated spray dryer exhaust gas.

15. The spray dryer of any of claims 12 comprising a biogas burner and a heat exchanger to transfer heat from the biogas burner to a feed to the spray dryer or recirculated spray dryer exhaust gas.
